(19) United States
(12) Patent Application Publication
(10) Pub. No.: US 2015/0348063 A1
(43) Pub. Date: Dec. 3, 2015

(54) BRAND CUSTOMIZED BOOK SERIES PUBLICATION

(71) Applicant: Sergey KONDRATOV, Moscow Region (RU)

(72) Inventor: Sergey Kondratov, Moscow (RU)

(21) Appl. No.: 14/759,600

(22) PCT Filed: Jan. 7, 2014
(86) PCT No.: PCT/IB2014/000549

§ 371 Date: Jul. 7, 2015

Related U.S. Application Data
(60) Provisional application No. 61/749,824, filed on Jan. 7, 2013.

(51) Int. Cl. G06Q 30/02; G06Q 30/06

(52) U.S. Cl. CPC G06Q 30/0201; G06Q 30/0621

(57) ABSTRACT

A method and system for creating collateral items is provided where a series of publications bearing the branding of a third party are made. The series of publications bear the color schemes, patterns or other identifying characteristics of a third party brand. A series of electronic publications bearing the branding of a third party are also provided where the series of publications bear the color schemes, patterns or other identifying characteristics of a third party brand.

### BACKGROUND

Many brands have associated with them iconic colors, color schemes, patterns, and devices. Examples include the Burberry plaid pattern, Louis Vuitton's pattern, the Tommy Hilfiger flag design and the like. These brands often issue, free of charge, or for a price, collateral items such as datebooks, pocketbooks, pens, eyeglass cases and the like when the brand's main item, such as a suit, purse, coat or other item is purchased.

These collateral items are often cast aside or seldom used by the brand's purchasers. Often these collateral items were never desired by the purchaser in the first place. Collateral items often do not hold the interest of purchasers because they are not principally sought by the purchaser aside from the main item. Also, such collateral items are often not of the same quality as the main item, and may only carry the brand's logo on an otherwise common item, resulting in the purchaser's disregard of these items. For all of these reasons collateral items fail to make an impact with both the purchaser and those who view the purchaser.

What is needed is a collateral item and method of creating collateral items which are sought after and desired in their own right. Moreover such collateral items should not become stale with the purchaser and should be items that are likely to be publicly display by the purchaser.

### SUMMARY OF THE INVENTION

According to various embodiments, a method and system for creating collateral items is disclosed. In one aspect, a series of publications bearing the branding of a third party are made. In another aspect, a series of publications bearing the color schemes, patterns or other identifying characteristics of a third party brand are made. In still another aspect, a series of electronic publications bearing the branding of a third party are made. In yet another aspect, a series of publications bearing the color schemes, patterns or other identifying characteristics of a third party brand are made.

### BRIEF DESCRIPTION OF THE DRAWINGS

FIG. 1 is a flow diagram showing a method of creating correlated publications and products.

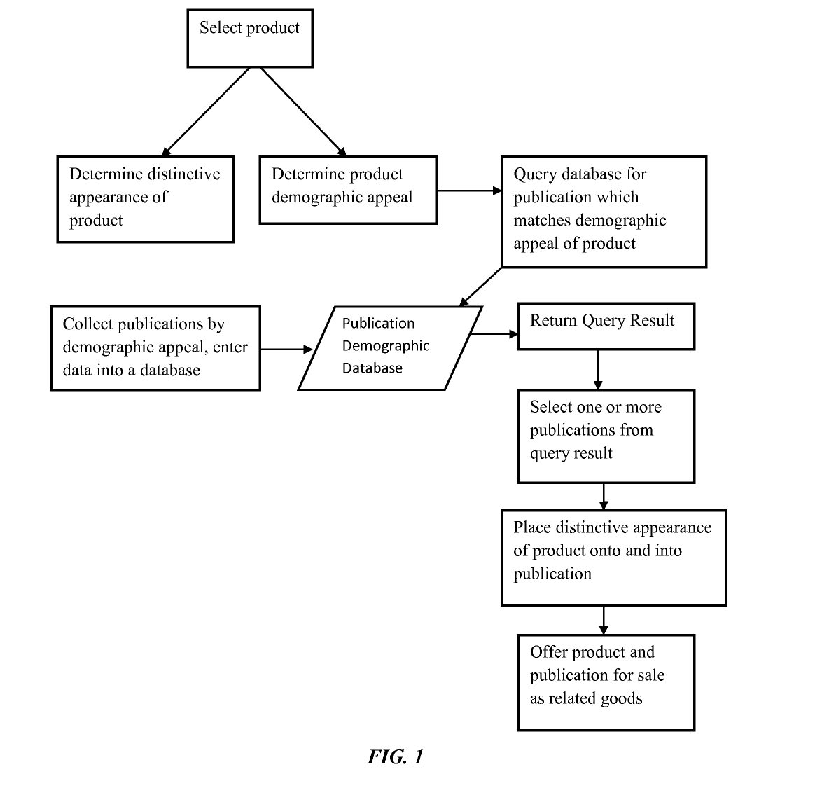

### DETAILED DESCRIPTION OF THE INVENTION

The present invention relates to a method and system for creating collateral items bearing the branding of third parties. The collateral items may be publications, series of publications, books or book series each bearing the branding, color scheme or devices associated with a brand. Or they may be electronic publications, series of electronic publications, electronic books or electronic book series each bearing the branding, color scheme or devices associated with a brand. Or, they may eBook readers capable of displaying the branding, color scheme or devices associated with a brand on their covers via electronic means such as a screen. In the foregoing description the terms publication and books are used interchangeably as examples. One of ordinary skill in the art would understand that these refer to the same category of collateral items—i.e. reading materials, whether they be books, magazines, comic books, or other literature.

In embodiments of the present invention a brand desires to have collateral items for sale or provided with one of its products to create a lifestyle brand experience. By way of example, assume that the product is a lady's purse, and that the collateral item is a book. The book has a coordinated outer appearance matching that of the purse. Now in order to create a fuller lifestyle experience, the book is sourced from a publisher of popular books that are desired by the same demographic as the purchaser. For example, a purse targeted to young girls may be connected with books such as those from the Harry Potter series. Whereas, a purse targeted to adult women may be connected with the Fifty Shades of Gray series.

In embodiments of the present invention the first step is to match a product to a publication or series of publications based on a shared demographic. The shared demographic could be very broad, for example males or females, citizens of a particular country or members of a particular ethnic group, or it could be quite narrow, for example residents of a particular town or region, or fans of a particular sports team, or it could be somewhere in the middle, for example fans of a particular sports team having a national or regional fan base. Once the publication is selected which fits the product, the publication is then altered to coincide with the product's brand features or general appearance. The connection between the publication and the product is made by altering the publication to include patterns, color schemes or artistic devices which match those of the product brand or product itself (“product features”). Alterations include altering the front or back cover of the publication to match the product features, or any of the inside pages and their borders. For example, the publication may have a front and back cover, pages separating chapters, prologues, epilogues, tables of contents, forewords, and blank pages. Any of these spaces may be modified to display the product features. For example, if the product is a Louis Vuitton purse, the publication front and back cover may match the classic artistic devices present on Louis Vuitton purses and interior sections may likewise carry the artistic devices. In this way the reader is reading a publication especially selected by the product brand to fit with the lifestyle conveyed by the product brand.

In further embodiments, multiple publications are selected to create a series, whether these are preexisting series, or a collection of literature especially selected by the product brand to be sold or provided as a collateral item. For example, a product brand may select a variety of books or publications which appeal to the same demographic as the product brand and issue them over time in a series which are altered to match the product brand's product features. It is important to note that product features includes both the overall appearance of a brand as well as individual products within that brand. For example particular leather patterns unique to a product may be replicated into the publication and/or the color pattern or devices of a particular brand may also be replicated into the publication.

Turning now to the implementation of embodiments of the present invention in electronic readers, such as the NOOK®, KINDLE®, and various smartphones and tablet personal computers that function as electronic readers (hereafter “electronic reader(s)” or “e-readers”), methods to coordinate the outer and inner appearance of the electronic reader with the product features are described. Where the electronic reader is a third party device itself, the outer cover may be altered to match the product features. Where the electronic reader is made to the product brand's specifications further customization is possible.

For example, where the electronic reader is made to the product brand's specifications the front and back cover, or one or the other, may be an LCD or other flat screen, as may the interior side of the cover, such that this flat screen is exposed on the outside of the electronic reader when in use. The screen thus provides ample space to display the product features to both the general public when the e-reader is in use in public and to the owner of the e-reader.

In one embodiment, in order to display the product features on the flat screen, a software module located within the memory of the electronic reader determines which eBook is currently being loaded or accessed by the user and communicates with the electronic reader application programming interface (API) to cause the flat screen cover to display the appropriate product's feature and optionally the eBook title.

In another embodiment, the electronic reader always displays the same product feature on the flat screen cover. This is achieved by a software module which instructs the API to cause the flat screen to display an image containing the product feature whenever the device is powered on.

Still further, the eBook itself may carry the product features as a border or within its text, or chapter separators, or anywhere else within the eBook.

In the preceding detailed description of embodiments of the invention, numerous specific details are set forth in order to provide a thorough understanding of the embodiments of invention. However, it is known to a person skilled in art that the embodiments of invention may be practiced with or without these specific details. In other instances methods, procedures and components known to persons of ordinary skill in the art have not been described in details so as not to unnecessarily obscure aspects of the embodiments of the invention. Furthermore, it is clear that the invention is not limited to these embodiments only. Numerous modifications, changes, variations, substitutions and equivalents will be apparent to those skilled in the art, without parting from the spirit and scope of the invention.

1. A method of coordinating one or more publications to a product comprising:
(a) determining the demographic appeal of a product having a design,
(b) selecting one or more publications having a demographic appeal which matches the demographic appeal of the product, and
(c) replicating the design of the product onto the one or more publications.

2. The method of claim 1 wherein the one or more publications are selected from the group comprising books, magazines or comic books.

3. The method of claim 1 wherein the design comprises a brand.

4. The method of claim 1 wherein the design comprising a color scheme.

5. The method of claim 1 wherein the design comprises a pattern.

6. The method of claim 1 wherein the design comprises a device.

7. The method of claim 1 wherein the one or more publications comprise a series.

8. A method of coordinating an eBook to a product comprising:
(a) determining the demographic appeal of a product having a design,
(b) selecting one or more eBooks having a demographic appeal which matches the demographic appeal of the product, and
(c) replicating the design of the product into the one or more eBooks.

9. The method of claim 8 wherein the one or more eBooks are selected from the group comprising books, magazines or comic books.

10. The method of claim 8 wherein the design comprises a brand.

11. The method of claim 8 wherein the design comprising a color scheme.

12. The method of claim 8 wherein the design comprises a pattern.

13. The method of claim 8 wherein the design comprises a device.

14. The method of claim 8 wherein the one or more publications comprise a series.

15. A method of coordinating an electronic reader to a product comprising:
(a) copying the design of at least one product,
(b) replicating the design of the at least one product onto an electronic reader having a cover.

16. The method of claim 15 wherein the cover is a flat screen.

17. The method of claim 16 wherein the flat screen is capable of displaying multiple designs linked to one or more eBooks.
